(19) United States
(12) Patent Application Publication
(10) Pub. No.: US 2022/0194854 A1
(43) Pub. Date: Jun. 23, 2022

(54) FLEXIBLE MORTAR COMPOSITIONS

(71) Applicant: SIKA TECHNOLOGY AG, Baar (CH)

(72) Inventors: Daniela HESSELBARTH, Zürich (CH); Tugba TURAN, Zürich (CH); Luz GRANIZO, Madrid (ES)

(73) Assignee: SIKA TECHNOLOGY AG, Baar (CH)

(21) Appl. No.: 17/611,395

(22) PCT Filed: May 14, 2020
(86) PCT No.: PCT/EP2020/063541

§ 371 Date: Nov. 15, 2021

(30) Foreign Application Priority Data
May 21, 2019 (EP) 19175676.6

(51) Int. Cl. C04B 24/42; C04B 28/14; C04B 14/06; C04B 14/28

(52) U.S. Cl. CPC C04B 24/42; C04B 28/14; C04B 2103/406; C04B 14/28; C04B 14/06

(57) ABSTRACT

Methods are disclosed in which an additive is used for controlling the flexibility of a hydraulic binder composition, where the additive includes a silane-functional polymer, the silane-functional polymer being a silane-functional polyurethane polymer and/or a silane-functional polyether.

### TECHNICAL FIELD

The invention relates the use of an additive for increasing the flexibility of a hydraulic binder composition. Further aspects of the invention are related to an additive for increasing the flexibility of a hydraulic binder composition, a method for increasing the flexibility of a hydraulic binder composition and a hydraulic binder composition.

### BACKGROUND ART

In construction industry, compositions based on hydraulic binders, such as e.g. mortar or concrete compositions, are widely used for various applications.

Mortar and concrete compositions typically comprise hydraulic binders, aggregates, water and optionally one or more additives for controlling certain properties of the compositions during processing, setting and/or in hardened state.

Mortars used for filling gaps, cracks, cavities and/or for reinforcing existing structures are also called grouts. Nowadays, various types of grouts exist for different kind of applications. For example, grouts are used for joining tiles, masonry and other types of building materials, as well as for filling joints and voids between such materials.

From a chemical point of view, mortars or grouts may be cement-based, polymer modified cement-based, or polymer based (e.g. based on reactive polymers, such as for example epoxy grouts). Each of these types of grouts has its advantages and disadvantages.

For example, WO 2014/029658 A1 (Sika Technology AG) describes a multi-purpose mortar or cement composition for (i) inhibiting the corrosion of steel in mortar or cement structures, (ii) repairing, filling and/or spraying damages, cracks, flaws and cavities in mortar or cement structures and/or (iii) surfacing, coating and/or protecting mortar or concrete surfaces.

WO 2014/194048 A1 (Laticrete International, Inc.) discloses grouts that include a urethane-acrylic hybrid polymer dispersion and a filler material. The grouts are described of being beneficial with regard to hardness, strength, durability, flexibility, water resistance, stain resistance, and faster cure or hardening times.

Although many of the grout compositions known so far can be satisfactory with regard to certain properties in practice, there is still room for improvement, especially with regard to flexibility, water resistance, and/or impact resistance. Thus, there is still a need to provide improved solutions.

### DISCLOSURE OF THE INVENTION

It is an object of the present invention to provide improved solutions for obtaining hydraulic binder compositions, especially mortar and/or grout compositions. In particular, it is desired to provide solutions which allow for increasing the flexibility of a hydraulic binder composition gradually, the increase depending on the amount of an additive added to the composition. In addition, preferably, the hydraulic binder compositions obtainable should have beneficial properties with regard to water resistance, waterproofness, impact resistance, adhesion to substrates and/or crack bridging.

Surprisingly, it has been found that the features of claim 1 achieve these objects. Thus, the core of the present invention is related to a use of an additive for increasing the flexibility of a hydraulic binder composition whereby the additive comprises a silane-functional polymer.

As it turned out, with a silane-functional polymer it is possible to efficiently increase the flexibility of a hydraulic binder composition, especially grout compositions, in a rather easy and reliable manner by varying the proportion of the inventive additive.

Thereby, it is possible to obtain waterproof hydraulic binder compositions with very high flexibilities and excellent mechanical properties.

In addition, the hydraulic binder compositions obtainable by using the inventive additive feature good adhesion to various substrates with minimum substrate preparation and even without the need of primers, can be used for effectively bridging rather large cracks in existing structures, and show high impact resistance. Nevertheless, the workability of the hydraulic binder compositions can still be kept on a good level such that the compositions can be used for various applications. In addition, it is possible to provide hydraulic binder compositions with rather short setting and hardening times, which is attractive for short-time repair work, e.g. of heavily used traffic infrastructures.

For example, when using the inventive additive, it is possible to obtain grout compositions, which can be used in demanding remedial works on concrete bridge structures, which include the requirement for void filling, fixing and sealing or bedding and grouting with free flowing materials. Typical examples are concrete repairs using formwork, high precision grouting under bridge bearing plates, or for cable duct grouting.

Also, thanks to the beneficial properties, it is even possible to replace certain joint systems and/or seal systems currently made of plastics with hydraulic binder compositions treated with the inventive additive. Thereby, the compatibility of the joint or sealing systems with other cement-based elements of an object to be repaired can be improved. This is especially interesting for traffic infrastructures, such as e.g. bridges, roadways and/or runways.

Furthermore, hydraulic binder compositions obtainable by using the inventive additive feature a high resistance to weathering and are color stable. Also, in contrast to hydraulic binder compositions comprising silicones, there is no problem to apply various coatings or paints onto the hydraulic binder compositions obtainable with the present invention.

Additional aspects of the invention are subject of further independent claims. Particularly preferred embodiments are outlined throughout the description and the dependent claims.

### WAYS OF CARRYING OUT THE INVENTION

A first aspect of the present invention is directed to the use of an additive for increasing the flexibility of a hydraulic binder composition whereby the additive comprises a silane-functional polymer, whereby the silane-functional polymer is a silane-functional polyurethane polymer and/or a silane-functional polyether.

In general, “flexibility” is the ability of a material to deform elastically and return to its original shape when the applied stress is removed. In the present context, in particular, the elastic modulus of the hydraulic binder composition in hardened state, especially after 7 days, preferably after 28 days of hardening, is taken as a measure for flexibility. The elastic modulus of an object is generally defined as the slope of its stress—strain curve in the elastic deformation region. A lower elastic modulus means a higher flexibility. The elastic modulus describes the resistance of the hardened hydraulic binder composition to elastic deformation. Preferably, the elastic modulus is determined according to DIN EN 12390-13:2014-06 (method A).

With the term “controlling the flexibility” it is meant that that due to the presence of the inventive additive, the flexibility of the hydraulic binder composition in hardened state is increased, when compared to a hardened hydraulic binder composition in which the inventive additive has been replaced by an equal proportion of water but otherwise has an identical composition.

Substance names beginning with “poly”, such as polyol or polyisocyanate, in the present document identify substances, which formally contain two or more per molecule of the functional groups that occur in their name.

The term “polymer” in the present document encompasses on the one hand a collective of chemically uniform macromolecules which nevertheless differ in respect of degree of polymerization, molar mass, and chain length, said collective having been prepared through a polymerization reaction (chain-growth addition polymerization, polyaddition, polycondensation). On the other hand the term also encompasses derivatives of such a collective of macromolecules from polymerization reactions, in other words compounds which have been obtained by reactions, such as additions or substitutions, for example, of functional groups on existing macromolecules and which may be chemically uniform or chemically nonuniform. The term “moreover” further embraces what are called prepolymers, these being reactive oligomeric preadducts whose functional groups have participated in the construction of macromolecules.

The term “polyurethane polymer” describes polymers with more than one urethane group in their structure. The term “urethane” refers to a carbamate ester group, as formed from the reaction of an isocyanate group and an alcoholic hydroxyl group. The term “polyurethane polymer” also encompasses all polymers which are prepared by the process known as the diisocyanate polyaddition process. This also includes those polymers which are virtually free or entirely free from urethane groups, but instead include urea or thiourethane groups. Examples of polyurethane polymers are polyether-polyurethanes, polyester-polyurethanes, polyether-polyureas, polyureas, polyester-polyureas, polyisocyanurates, and polycarbodiimides.

The term “polyalkylene glycol” is used synonymously with the term “polyether” or the term “polyoxyalkylene” and describes a linear or branched polymer consisting of alkyl ether repeating units. Accordingly, polyethers in the meaning of the present invention are solely based on alkyl ethers and not substituted, for example perfluorated, alkyl ethers. Pending alkyl groups, however, such as methyl groups in the backbone as it is the case for polypropylene glycol, are within the definition of polyethers used herein.

In the present document, the terms “silane” and “organosilane” respectively identify compounds which in the first instance have at least one, customarily two or three, hydrolyzable groups bonded directly to the silicon atom via Si—O— bonds, more particularly alkoxy groups or acyloxy groups, and in the second instance have at least one organic radical bonded directly to the silicon atom via an Si—C bond. Silanes with alkoxy or acyloxy groups are also known to the person skilled in the art as organoalkoxysilanes and organoacyloxysilanes, respectively. “Tetraalkoxysilanes”, consequently, are not organosilanes under this definition.

Correspondingly, the term “silane group” refers to the silicon-containing group bonded to the organic silane radical bonded via the Si—C bond. The silanes, and their silane groups, have the property of undergoing hydrolysis on contact with moisture. In so doing, they form organosilanols, these being organosilicon compounds containing one or more silanol groups (Si—OH groups) and, by subsequent condensation reactions, organosiloxanes, these being organosilicon compounds containing one or more siloxane groups (Si—O—Si groups).

The term “silane-functional” refers to compounds which have silane groups. “Silane-functional polymers” accordingly, are polymers which have at least one silane group.

“Aminosilanes” and “mercaptosilanes” are terms used for organosilanes whose organic radical has at least one amino group or at least one mercapto group, respectively.

The term “primer” in the present document identifies a thin layer typically thinner than 1 mm, more particularly between 1 and 200 μm, preferably between 1 and 100 μm, of an adhesion promoter composition, which is applied as a preliminary coat to the surface of a substrate and results in an improvement in the adhesion of the adhesive to a substrate.

The “molecular weight” in connection with polymers in the present document is understood always to refer to the average molecular weight, if not otherwise specified.

“Average molecular weight” is understood to mean the number-average Mₙ of an oligomeric or polymeric mixture of molecules or radicals, which is typically determined by means of gel permeation chromatography (GPC) against polystyrene as standard.

“Weight percent” or “percentage by weight”, and its abbreviation “wt.-%” refer to the weight percentage of a certain compound in a total composition, if not otherwise defined. The terms “weight” and “mass” are used interchangeably in this document and refer to the mass as a property of a physical body and commonly measured in kilograms (kg).

“Room temperature” refers to a temperature of 23° C.

All industrial standards and norms cited in this document refer to the respective edition in force on the time of filing of the first application of this invention, if not otherwise defined.

In the present context, the expression “hydraulic binder” in particular stands for inorganic and/or mineral materials that can harden because of chemical reactions with water producing hydrates. Preferably, the hydrates produced are not water-soluble. In particular, the chemical reactions with water of the hydraulic binder takes essentially place independently of the water content. This means that the hydraulic binder can harden and retain its strength even when exposed to water, e.g. underwater or under high humid conditions.

However, in the present context, it is not absolutely necessary to use water as a hardening means. Without being bound by theory, it is believed that the silane-functional polymer can react chemically with the hydraulic binder, especially if the hydraulic binder comprises aluminate cement and/or a sulphoaluminate cement, especially a calcium aluminate cement and/or a calcium sulphoaluminate cement.

A “hydraulic binder composition” is a composition comprising a hydraulic binder and optionally further components.

With regard to the hydraulic binder composition, the term “the hydraulic binder composition in dry state” refers to the hydraulic binder composition without the additive and without any water.

Especially, the hydraulic binder composition is used in the form of a dry composition. This means that the hydraulic binder composition, before adding the additive, is essentially free of water or an amount of water is below 1 wt. %, in particular below 0.5 wt. %, especially below 0.1 wt. %, with respect to the total weight of the hydraulic binder composition.

A preferred amount of hydraulic binder in the hydraulic binder composition is 15-50 wt. %, in particular 20-45 wt. %, especially 30-40 wt. %, with respect to the weight of hydraulic binder composition in dry state.

Preferably, the hydraulic binder comprises or consists of Portland cement, aluminate cement, sulphoaluminate cement, latent hydraulic and/or pozzolanic binder materials, calcium sulfate hemihydrate, anhydrite and/or hydrated lime.

Preferred Portland cement is according to norm EN 197, in particular of type CEM I. The term “alumina cement” stands in particular for a cement with an aluminum content, measured as Al₂O₃, of at least 30 wt. %, especially at least 35 wt. %, in particular 35-58 wt. %. Preferably, the alumina cement is alumina cement according to standard EN 14647. Preferably, the sulphoaluminate cement is calcium sulphoaluminate cement.

The term “latent hydraulic and/or pozzolanic binder materials” stands in particular for type II concrete additives with latent hydraulic and/or pozzolanic character according to EN 206-1. In particular, the latent hydraulic or pozzolanic binder material comprises or consists of slag, fly ash, silica fume, metakaolin and/or natural pozzolanes. Thereby, slag and/or fly ash, in particular furnace slag is especially preferred.

Calcium sulfate hemihydrate or CaSO₄.0.5 H₂O may be present as α-hem i-hydrate or β-hemi-hydrate. Anhydrite is in particular anhydrite II and/or anhydrite III, whereas hydrated lime stands for calcium hydroxide.

Especially preferred, the hydraulic binder comprises aluminate cement and/or sulphoaluminate cement. According to a preferred embodiment, the hydraulic binder additionally comprises Portland cement and optionally calcium sulfate hemihydrate and/or anhydrite.

Especially, the hydraulic binder comprises Portland cement as well as aluminate cement and/or sulphoaluminate cement. In this case, preferably, a proportion of Portland cement is higher than a proportion of aluminate cement and/or sulphoaluminate cement. In particular, a weight ratio of Portland cement to aluminate cement and/or sulphoaluminate cement from 0.1-10, especially 0.2-5, in particular 0.3-2, in particular preferred 0.4-1.0 or 0.5-0.9.

According to a preferred embodiment, the hydraulic binder comprises:
5-25 wt. %, in particular 10-20 wt. %, especially 13-17 wt. %, Portland cement;
10-30 wt. %, in particular 15-25 wt. %, especially 18-22 wt. %, aluminate cement and/or sulphoaluminate cement;
optionally 0.01-5 wt. %, especially 0.1-2 wt. %, in particular 0.2-1 wt. %, calcium sulfate hemihydrate and/or anhydrite;
optionally 0.1-10 wt. %, in particular 0.5-5 wt. %, especially 1-4 wt. %, hydrated lime;
   whereby all amounts are with respect to the total weight of the hydraulic binder composition in dry state.

In particular, the hydraulic binder composition comprises aggregates. In particular, the aggregates have a particle density >2′000 kg/m³, especially >2′100 kg/m³ or >2′200 kg/m³.

Especially, the aggregates are selected from sand, quartz, calcium carbonate, gravel, basalt and/or metallic aggregates, preferably from sand and/or calcium carbonate.

In particular, the hydraulic binder composition comprises 25-75 wt. %, in particular 35-65 wt. %, especially 50-60 wt. %, of aggregates, with respect to the weight of the hydraulic binder composition in dry state.

A particle size of the aggregates preferably is 0.0005-10 mm, especially 0.001-5 mm, preferably 0.005-4 mm.

In the present context, the particle size can e.g. be determined by laser diffraction as described in ISO 13320:2009. Preferably, a particle size of non-spherical or irregular particles is represented by the equivalent spherical diameter of a sphere of equivalent volume. Especially, the lower values of the ranges given for the particle size represent D1 values whereas the upper values of the ranges given for the particle size represent D99 values. Put differently, in this case, 1% of the particles have a lower particle size than the lower value of a range, whereas 1% of the particles have a larger particle size than the upper value of a range.

According to a preferred embodiment the aggregates comprise sand and calcium carbonate, whereby, preferably, a weight ratio of sand to calcium carbonate is from 0.5-5, especially 1-4, in particular 1.5-3.5.

Furthermore, it can be beneficial if the hydraulic binder composition comprises at least one mortar additive selected from the group consisting of setting time regulators, plasticizers, defoamers, rheology modifiers, thixotropic agents, aerating and/or foaming agents, anti-shrinkage agents, corrosion inhibitors, fire-retarding agents, fibers, and chromium reducers.

Preferably, a proportion of the mortar additives in total is from 0-10 wt. %, especially 1-10 wt. % with respect to the weight of the hydraulic binder composition in dry state.

Especially, the hydraulic binder composition comprises a plasticizer, whereby the plasticizer is in particular selected from the group of lignosulfonates, gluconates, naphtalenesulfonates, melamine sulfonates, vinyl copolymers and/or polycarboxylate ethers. Polycarboxylate ethers are preferred.

A proportion of polycarboxylate ethers is preferably from 0.001-1 wt. %, in particular 0.05-0.1 wt. %, with respect to the weight of the mortar composition in dry state.

According to the invention, the inventive additive comprises or consists of a silane-functional polymer. Preferably, these polymers are organic polymers, which excludes silicones (polysiloxanes). Organic polymers, compared to silicone-based polymers, have the advantage of better adhesion properties and better overpaintability and lower tendency for staining.

Most preferred silane-functional polymers are liquid silane-functional polymers. “Liquid” means that the silane-functional polymers are liquid under standard conditions. Thus, preferably, liquid silane-functional polymers are used.

Preferably, the silane-functional polymers are linear or branched organic polymers, most preferably linear polymers.

Preferably, the silane-functional polymers have terminal reactive silane groups, more preferably exclusively terminal silane groups, at the ends of the polymer backbones.

Preferably, the silane-functional polymer has one, two or more groups, more preferably end groups, of the formula (I):

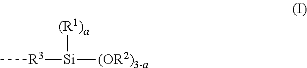

whereby
the radical R¹ is an alkyl group having 1 to 8 C atoms, more particularly a methyl group or an ethyl group;
the radical R² is an acyl or alkyl group having 1 to 5 C atoms, more particularly a methyl group or an ethyl group or an isopropyl group. Most preferably R² is an ethyl group;
the radical R³ is a linear or branched, optionally cyclic, alkylene group having 1 to 12 C atoms, optionally with aromatic moieties, and optionally with 1 or more heteroatoms, more particularly with one or more nitrogen atoms;
the index a has a value of 0 or 1 or 2, more particularly a value of 0.

Within a silane group of the formula (I), R¹ and R², each independently of one another, are the radicals described. Thus, for example, possible compounds of the formula (I) include those which represent the ethoxy-dimethoxy-alkylsilanes (R²=methyl, R²=methyl, R²=ethyl).

Preferably, the silane-functional polymer is a polymer with a polyalkylene glycol backbone, especially a polypropylene glycol backbone or a polyethylene glycol polypropylene glycol mixed backbone. This backbone may comprise urethane linkages, preferably between 2 and 6 urethane linkages between and at the end of the polyether segments.

Preferably, the silane-functional polymer has a molecular weight Mn, determined by GPC, of between 4000 and 30 000 g/mol, preferably between 8000 to 30 000 g/mol, wherein in the case of a polydisperse polymer, this refers to the main peak size of the molecular weight Mn distribution as obtained by GPC against polystyrene.

In particular, the silane-functional polymer is a polymer with one, two or more end groups according to formula (I), especially a dialkoxy(alkyl)silyl end group and/or a trialkoxysilyl end group, preferably a dimethoxy(methyl)silyl end group and/or a trimethoxysilyl end group. Thereby, preferably, the silane-functional polymer has a polyalkylene glycol backbone, also called polyether backbone, especially a polypropylene glycol backbone, wherein the backbone may furthermore contain urethane linker groups between polyether segments.

Especially preferred, the silane-functional polymer is polymer with a dialkoxy(alkyl)silylalkylcarbamate end group and/or a trialkoxysilylalkylcarbamate end group, in particular a trimethoxysilylpropylcarbamat and/or a dimethoxy(methyl)silylmethylcarbamat end group. Thereby, preferably, the silane-functional polymer has a polyalkylene glycol backbone, especially a polypropylene glycol backbone, wherein the backbone may furthermore contain urethane linker groups between polyether segments.

According to a preferred embodiment, the silane-functional polymer is a silane-functional polyurethane polymer, a silane-functional poly(meth)acrylate polymer and/or a silane-functional polyether polymers. Silane-functional polyurethane polymers are highly preferred.

In particular, according to a first example, the silane-functional polymer is silane-functional polyurethane polymer obtainable by the reaction of a silane having at least one group that is reactive toward isocyanate groups, with a polyurethane polymer which contains isocyanate groups (in the following, such kind of silane-functional polyurethane polymers are referred to as polymer P1). This reaction is carried out preferably in a stoichiometric ratio of the groups that are reactive toward isocyanate groups to the isocyanate groups of 1:1, or with a slight excess of groups that are reactive toward isocyanate groups, meaning that the resulting silane-functional polyurethane polymer P1 is preferably entirely free of isocyanate groups.

The silane which has at least one group that is reactive toward isocyanate groups is, for example, a mercaptosilane, an aminosilane or a hydroxysilane, more particularly an aminosilane. The aminosilane is preferably an aminosilane AS of the formula (Ia),

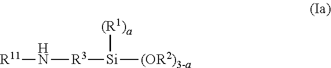

where R¹, R², R³, and a have already been described above, and R¹¹ is a hydrogen atom or is a linear or branched hydrocarbon radical having 1 to 20 C atoms that optionally contains cyclic moieties, or is a radical of the formula (II).

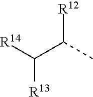

In this formula the radicals R¹² and R¹³, independently of one another, are a hydrogen atom or a radical from the group encompassing —R¹⁵, —CN, and —COOR¹⁵.

The radical R¹⁴ is a hydrogen atom or is a radical from the group encompassing —CH₂—COOR¹⁵, —COOR¹⁵, CONHR¹⁵, —CON(R¹⁵)₂, —CN, —NO₂, —PO(OR¹⁵)₂, —SO₂R¹⁵, and —SO₂OR¹⁵

The radical R¹⁵ is a hydrocarbon radical having 1 to 20 C atoms that optionally comprises at least one heteroatom.

Examples of suitable aminosilanes AS are primary aminosilanes such as 3-aminopropyltriethoxysilane, 3-aminopropyldiethoxymethylsilane; secondary aminosilanes such as N-butyl-3-aminopropyltriethoxysilane, N-phenyl-3-aminopropyltriethoxysilane; the products of the Michael-like addition of primary aminosilanes such as 3-aminopropyltriethoxysilane or 3-amino-propyldiethoxymethylsilane onto Michael acceptors such as acrylonitrile, (meth)acrylic esters, (meth)acrylamides, maleic diesters and fumaric diesters, citraconic diesters and itaconic diesters, examples being dimethyl and diethyl N-(3-triethoxysilylpropyl)aminosuccinate; and also analogs of the stated aminosilanes having methoxy or isopropoxy groups instead of the preferred ethoxy groups on the silicon. Particularly suitable aminosilanes AS are secondary aminosilanes, more particularly aminosilanes AS in which R⁴ in formula (III) is different from H. Preferred are the Michael-like adducts, more particularly diethyl N-(3-triethoxysilylpropyl)aminosuccinate.

The term “Michael acceptor” in the present document identifies compounds which on the basis of the double bonds they contain, activated by electron acceptor radicals, are capable of entering into nucleophilic addition reactions with primary amino groups (NH₂ groups) in a manner analogous to Michael addition (hetero-Michael addition).

Examples of suitable polyurethane polymers containing isocyanate groups for the preparation of a silane-functional polyurethane polymer P1 include polymers which are obtainable by the reaction of at least one polyol with at least one polyisocyanate, more particularly a diisocyanate. This reaction may take place by the polyol and the polyisocyanate being reacted by customary methods, as for example at temperatures of 50° C. to 100° C., optionally with accompanying use of suitable catalysts, the polyisocyanate being metered such that its isocyanate groups are present in a stoichiometric excess in relation to the hydroxyl groups of the polyol.

More particularly the excess of polyisocyanate is preferably selected such that in the resulting polyurethane polymer, after the reaction of all hydroxyl groups of the polyol, the remaining free isocyanate group content is from 0.1 to 5 wt %, preferably 0.1 to 2.5 wt %, more preferably 0.2 to 1 wt %, based on the overall polymer.

The polyurethane polymer thus obtained has at least two urethane groups, obtained from the reaction of the OH groups of the polyol with the NCO groups of the polyisocyanate. However, depending on the molar ratio of the polyol and polyisocyanate, significant chain extension may occur and longer polyurethane polymers with more urethane bonds may be obtained.

The polyurethane polymer may optionally be prepared with accompanying use of plasticizers, in which case the plasticizers used contain no groups that are reactive toward isocyanates.

Preferred polyurethane polymers with the stated amount of free isocyanate groups are those obtained from the reaction of diisocyanates with high molecular mass diols in an NCO:OH ratio of 1.5:1 to 2:1.

Suitable polyols for preparing the polyurethane polymer are, in particular, polyether polyols also called polyoxyalkylene polyols or oligoetherols or polyalkylene glycols, polyester polyols, and polycarbonate polyols, and also mixtures of these polyols. Most preferred polyols for preparing the polyurethane polymer are polyether polyols, also called polyoxyalkylene polyols or oligoetherols or polyalkylene glycols.

Especially suitable polyether polyols, also called polyoxyalkylene polyols or oligoetherols or polyalkylene glycols, are those which are polymerization products of ethylene oxide, 1,2-propylene oxide, 1,2- or 2,3-butylene oxide, oxetane, tetrahydrofuran, or mixtures thereof, optionally polymerized with the aid of a starter molecule having two or more active hydrogen atoms, such as water, ammonia, for example, or compounds having two or more OH or NH groups such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the stated compounds. Use may be made both of polyoxyalkylene polyols which have a low degree of unsaturation (measured by ASTM D-2849-69 and expressed in milliequivalents of unsaturation per gram of polyol (meq/g)), prepared for example by means of double metal cyanide complex catalysts (DMC catalysts), and of polyoxyalkylene polyols having a higher degree of unsaturation, prepared for example by means of anionic catalysts such as NaOH, KOH, CsOH, or alkali metal alkoxides.

Particularly suitable are polyoxyethylene polyols and polyoxypropylene polyols, more particularly polyoxyethylene diols, polyoxypropylene diols, polyoxyethylene triols, and polyoxypropylene triols.

Especially suitable are polyoxyalkylene diols or polyoxyalkylene triols having a degree of unsaturation of less than 0.02 meq/g and having a molecular weight in the range from 1000 to 30 000 g/mol, and also polyoxyethylene diols, polyoxyethylene triols, polyoxypropylene diols, and polyoxypropylene triols having a molecular weight of 400 to 20 000 g/mol. Likewise particularly suitable are so-called ethylene oxide-terminated (“EO-endcapped”, ethylene oxide-endcapped) polyoxypropylene polyols. The latter are special polyoxypropylene-polyoxyethylene polyols which are obtained, for example, by subjecting pure polyoxypropylene polyols, more particularly polyoxypropylene diols and triols, to further alkoxylation with ethylene oxide after the end of the polypropoxylation reaction, and which therefore have primary hydroxyl groups. Preferred in this case are polyoxypropylene-polyoxyethylene diols and polyoxypropylene-polyoxyethylene triols.

Additionally suitable are hydroxyl group terminated polybutadiene polyols, examples being those prepared by polymerization of 1,3-butadiene and allyl alcohol or by oxidation of polybutadiene, and their hydrogenation products.

Additionally suitable are styrene-acrylonitrile grafted polyether polyols, of the kind available commercially, for example, under the trade name Lupranol® from BASF Polyurethanes GmbH, Germany.

Especially suitable as polyester polyols are polyesters which carry at least two hydroxyl groups and are prepared by known processes, particularly by the polycondensation of hydroxycarboxylic acids or the polycondensation of aliphatic and/or aromatic polycarboxylic acids with dihydric or polyhydric alcohols.

Especially suitable polyester polyols are those prepared from di- to trihydric alcohols such as, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or mixtures of the aforesaid alcohols, with organic dicarboxylic acids or their anhydrides or esters, such as, for example, succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid, and trimellitic anhydride, or mixtures of the aforesaid acids, and also polyester polyols of lactones such as ε-caprolactone, for example.

Particularly suitable are polyester diols, especially those prepared from adipic acid, azelaic acid, sebacic acid, dodecanedicarboxylic acid, dimer fatty acid, phthalic acid, isophthalic acid, and terephthalic acid as dicarboxylic acid, or from lactones such as ε-caprolactone, for example, and from ethylene glycol, diethylene glycol, neopentyl glycol, 1,4-butanediol, 1,6-hexanediol, dimer fatty acid diol, and 1,4-cyclohexanedimethanol as dihydric alcohol.

Especially suitable polycarbonate polyols are those obtainable by reaction, for example, of the abovementioned alcohols, used for synthesis of the polyester polyols, with dialkyl carbonates such as dimethyl carbonate, diaryl carbonates such as diphenyl carbonate, or phosgene. Particularly suitable are polycarbonate diols, especially amorphous polycarbonate diols.

Other suitable polyols are poly(meth)acrylate polyols.

Likewise suitable, moreover, are polyhydrocarbon polyols, also called oligohydrocarbonols, examples being polyhydroxy-functional ethylene-propylene, ethylene-butylene or ethylene-propylene-diene copolymers, as produced for example by Kraton Polymers, USA, or polyhydroxy-functional copolymers of dienes such as 1,3-butanediene or diene mixtures and vinyl monomers such as styrene, acrylonitrile or isobutylene, or polyhydroxy-functional polybutadiene polyols, examples being those which are prepared by copolymerization of 1,3-butadiene and allyl alcohol and which may also have been hydrogenated.

Additionally suitable are polyhydroxy-functional acrylonitrile/butadiene copolymers of the kind preparable, for example, from epoxides or amino alcohols and carboxyl-terminated acrylonitrile/butadiene copolymers, which are available commercially under the name Hypro® (formerly Hycar®) CTBN from Emerald Performance Materials, LLC, USA.

These stated polyols preferably have a molecular weight of 250 to 30 000 g/mol, more particularly of 1000 to 30 000 g/mol, and an average OH functionality in the range from 1.6 to 3.

Particularly suitable polyols are polyester polyols and polyether polyols, more particularly polyoxyethylene polyol, polyoxypropylene polyol, and polyoxypropylene-polyoxyethylene polyol, preferably polyoxyethylene diol, polyoxypropylene diol, polyoxyethylene triol, polyoxypropylene triol, polyoxypropylene-polyoxyethylene diol, and polyoxypropylene-polyoxyethylene triol.

Further to these stated polyols it is possible as well to use small amounts of low molecular weight dihydric or polyhydric alcohols such as, for example, 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher alcohols, low molecular weight alkoxylation products of the aforesaid dihydric and polyhydric alcohols, and also mixtures of the aforesaid alcohols, when preparing the polyurethane polymer having terminal isocyanate groups.

As polyisocyanates for the preparation of the polyurethane polymer it is possible to use commercially customary aliphatic, cycloaliphatic or aromatic polyisocyanates, more particularly diisocyanates. Suitable diisocyanates by way of example are those whose isocyanate groups are bonded in each case to one aliphatic, cycloaliphatic or arylaliphatic C atom, also called “aliphatic diisocyanates”, such as 1,6-hexamethylene diisocyanate (HDI), 2-methylpentamethylene 1,5-diisocyanate, 2,2,4- and 2,4,4-trimethyl-1,6-hexamethylene diisocyanate (TMDI), 1,12-dodecamethylene diisocyanate, lysine diisocyanate and lysine ester diisocyanate, cyclohexane 1,3-diisocyanate, cyclohexane 1,4-diisocyanate, 1-isocyanato-3,3,5-trimethyl-5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis(1-isocyanato-1-methylethyl)naphthalene; and also diisocyanates having isocyanate groups bonded in each case to one aromatic C atom, also called “aromatic diisocyanates”, such as 2,4- and 2,6-tolylene diisocyanate (TDI), 4,4′-, 2,4′-, and 2,2′-diphenylmethane diisocyanate (MDI), 1,3- and 1,4-phenylene diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI); oligomers and polymers of the aforementioned isocyanates, and also any desired mixtures of the aforementioned isocyanates.

Suitable methoxysilane-funtional polymers P1 are for example available commercially under the trade name Polymer ST50 from Hanse Chemie AG, Germany, and also under the trade name Desmoseal® by Bayer MaterialScience AG, Germany.

Methoxysilane-functional polymers P1 are preferably used.

According to a second example, the silane-functional polymer is a silane-functional polyurethane polymer obtainable through the reaction of isocyanotosilane IS with a polymer which has functional end groups that are reactive toward isocyanates, these end groups being more particularly hydroxyl groups, mercapto groups and/or amino groups (in the following, such kind of silane-functional polyurethane polymers are referred to as polymer P2). This reaction takes place in a stoichiometric ratio of the isocyanate groups to the functional end groups that are reactive toward isocyanate groups of 1:1, or with a slight excess of the functional end groups that are reactive toward isocyanate groups, at temperatures, for example, of 20° C. to 100° C., optionally with accompanying use of catalysts.

Suitability as isocyanatosilane IS is possessed by compounds of the formula (Ib)

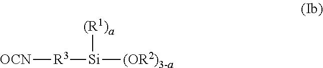

where R¹, R², R³, and a have already been described earlier. Examples of suitable isocyanatosilanes IS of the formula (Ib) are 3-isocyanatopropyltriethoxysilane, 3-isocyanatopropyldiethoxymethylsilane, and their analogs with methoxy or isopropoxy groups in place of the ethoxy groups on the silicon atom.

As functional end groups reactive toward isocyanate groups, the polymer preferably has hydroxyl groups. Suitable polymers having hydroxyl groups are, on the one hand, high molecular weight polyoxyalkylene polyols already identified, preferably polyoxypropylene diols having a degree of unsaturation of less than 0.02 meq/g and having a molecular weight in the range from 4000 to 30 000 g/mol, more particularly those having a molecular weight in the range from 8000 to 30 000 g/mol.

Also suitable on the other hand are polyurethane polymers having hydroxyl groups, especially terminated with hydroxyl groups, for reaction with isocyanatosilanes IS of the formula (Ib). Polyurethane polymers of this kind are obtainable through the reaction of at least one polyisocyanate with at least one polyol. This reaction may be accomplished by bringing the polyol and the polyisocyanate to reaction by customary processes, at temperatures of 50° C. to 100° C., for example, optionally with accompanying use of suitable catalysts, the polyol being metered such that its hydroxyl groups are in a stoichiometric excess in relation to the isocyanate groups of the polyisocyanate. Preferred is a ratio of hydroxyl groups to isocyanate groups of 1.3:1 to 4:1, more particularly of 1.8:1 to 3:1. The polyurethane polymer may optionally be prepared with accompanying use of plasticizers, in which case the plasticizers used contain no groups reactive toward isocyanates. Suitable for this reaction are the same polyols and polyisocyanates already referenced as being suitable for the preparation of a polyurethane polymer containing isocyanate groups that is used for preparing a silane-functional polyurethane polymer P1.

Most preferred polymers P2 are polyalkylene glycol polyols, in particular diols, that were endcapped with 3-isocyanatopropyl-trimethoxysilane, 3-isocyanatopropyl-dimethoxymethylsilane, isocyanatomethyl-dimethoxymethylsilane, isocyanatomethyl-trimethoxysilane, and their analogs with ethoxysilane groups instead of methoxysilane groups. Such endcapping yields urethane-terminated polyethers with alkoxysilane functional groups. Since they possess more than one urethane group, they can be denoted as polyurethanes.

Suitable methoxysilane-functional polymers P2 are for example available commercially under the trade names SPUR+® 1010LM, 1015LM, and 1050MM from Momentive Performance Materials Inc., USA, and also under the trade names Geniosil® STP-E15, STP-10, and STP-E35 from Wacker Chemie AG, Germany, and also under the trade name Incorez STP from Sika Incorez, UK. Methoxyoxysilane-functional polymers P2 are preferably used.

According to a third example the silane-functional polymer is a silane-functional polymer which is obtainable by a hydrosilylation reaction of polymers, having terminal double bonds, examples being poly(meth)acrylate polymers or polyether polymers, more particularly of allyl-terminated polyoxyalkylene polymers, described for example in U.S. Pat. Nos. 3,971,751 and 6,207,766, the disclosure content of which is hereby included (in the following, such kind of silane-functional polyurethane polymers are referred to as polymer P3).

Suitable methoxysilane-functional polymers P3 are available commercially for example under the trade names MS-Polymer® S203(H), S303(H), S227, S810, MA903, and S943, Silyl® SAX220, SAX350, SAX400, and SAX725, Silyl® SAT350, and SAT400, and also XMAP® SA100S, and SA310S from Kaneka Corp., Japan, and also under the trade names Excestar® S2410, S2420, S3430, S3630, W2450, and MSX931 from Asahi Glass Co, Ltd., Japan. Methoxysilane-functional polymers P3 are preferably used.

It is also possible, moreover, as silane-functional polymer to use other silane-functional polymers that are available commercially, examples being those available under the trade name Tegopac® from Evonik Industries, more particularly Tegopac® Seal 100, Tegopac® Bond 150, Tegopac® Bond 250.

The silane-functional polymer preferably is used with a proportion of 0.01-60 wt. %, especially 1-50 wt. %, in particular 2-30 wt. %, with respect to the overall weight of the hydraulic binder composition and the additive.

According to a preferred embodiment, the silane-functional polymer is used with a proportion of 15-50 wt. %, especially 20-35 wt. %, in particular 22-32 wt. %, with respect to the overall weight of the hydraulic binder composition and the additive. With such a proportion, the hydraulic binder composition in hardened state will have a very high flexibility. At the same time a significant compressive strength is achieved.

According to another preferred embodiment, the silane-functional polymer is used with a proportion of 0.01-10 wt. %, especially 1-5 wt. %, in particular 2-4 wt. %, with respect to the overall weight of the hydraulic binder composition and the additive. With such a proportion, the hydraulic binder composition will have a lower flexibility compared to the embodiment with 15-50 wt. % polymer described above, but still a higher flexibility than a hydraulic binder composition without a silane-functional polymer. At the same time a high compressive strength can be achieved.

Thus, by changing the proportion of the silane-functional polymer, the flexibility of the hydraulic binder composition can be controlled. The higher the amount added, the higher the increase in flexibility, while other important properties of the hydraulic binder composition are not negatively affected as long as the amount is within the limits specified above.

Preferably, the silane-functional polymer is used in combination with one or more of the following substances: (i) a catalyst for the hydrolysis and/or condensation of the silane-functional polymer, (ii) an adhesion promoter, (iii) a surfactant, (iv) hard material particles and (v) fibers. Thus, in a preferred embodiment, one or more of these substances are part of the additive. Thereby, the additive can be in the form of a one-component additive, of a two or multi-component additive or in the form of a kit-of-parts (cf. detailed explanations below).

Preferably, the catalyst for the hydrolysis and/or condensation of the silane-functional polymer is selected from the group consisting of metal complexes, such as tin complexes, or amine bases, such as amidine or guanidine compounds. Such kind of catalysts are well known to the person of average skill in the field of silane-functional polymers.

Most preferred, the catalyst is chosen from metal complexes, in particular from tin complexes.

A suitable amount of the catalyst for the hydrolysis and/or condensation of the silane-functional polymer, especially a metal complex, in particular a tin complex, is from 0-3 wt. %, preferably 0.01-1 wt. %, especially 0.02-0.5 or 0.03-0.2 wt.-%, with respect to the overall weight of the hydraulic binder composition and the additive.

However, due to the alkalinity of the hydraulic binder, it is not absolutely necessary to include such a catalyst for the curing of silane-functional polymers, since those reaction mechanisms are commonly base-catalyzed and may proceed sufficiently fast in the rather alkaline reaction milieu of the mixed two-component composition.

The optionally used adhesion promotor is chemically different from silane-functional polymer. Especially, the adhesion promotor is an organosilane, in particular a silane having a primary amino group. Such an adhesion promotor improves the adhesion of the hydraulic composition on many substrates.

Examples of preferred adhesion promotors based on silanes having primary amino groups include 3-Aminopropyl trimethoxysilane and 3-Aminopropyl triethoxysilane.

Silanes having primary amino groups additionally can serve as catalysts for the hydrolysis and/or condensation of silane-functional polymers having silane groups.

A suitable amount of the adhesion promotor, especially an organosilane, in particular a silane having a primary amino group, is from 0-3 wt. %, preferably 0.01-1 wt. %, especially 0.02-0.5 or 0.03-0.2 wt.-%, with respect to the overall weight of the hydraulic binder composition and the additive.

The surfactant preferably is a non-ionic surfactant. Especially, the non-ionic surfactant is a homopolymer or a copolymer of alkylene oxides, optionally end capped with an alkyl group. Preferred alkylene oxides are ethylene oxide (EO), propylene oxide (PO) and/or butylene oxide (BO). A highly preferred non-ionic surfactant is a polypropylene glycol monoalkyl ether.

Preferably, a molecular weight M_{w} of the non-ionic surfactant, especially a homopolymer or a copolymer of alkylene oxides that optionally is end capped with an alkyl group, is from 500-5′000 g/mol, in particular 800-2′000 g/mol, especially 1′000-1′700 g/mol.

Such kind of non-ionic surfactants are e.g. available from Dow Chemical under the tradename Dowfax™.

A suitable amount of the non-ionic surfactant, especially a homopolymer or a copolymer of alkylene oxides, is from 0-15 wt. %, preferably 0.1-12 wt. %, especially 1-10, in particular 3-7 wt.-%, with respect to the overall weight of the hydraulic binder composition and the additive.

According to a further beneficial embodiment, the silane-functional polymer is used in combination with hard material particles. Hard material particles help to increase the compression strength of the hydraulic binder compositions while keeping the flexibility.

Especially, the hard material particles have a hardness (Vickers hardness, 50 g) of >1′200 kg/mm², especially >1′500 kg/mm², in particular >1′800 kg/mm², preferably >2′000 kg/mm². Especially, the hard material particles are selected from SiC, Si₃N₄, TiC, TiN, diamond, ZrO₂, Al₂O₃, and/or WC.

A particle size of the hard material particles can be in the range of 10 nm to 10 mm, especially 1 μm to 5 mm, in particular 0.1 mm to 3 mm.

A proportion of the hard materials particles is preferably from 0.1-30 wt. %, in particular 1-25 wt. %, especially 3-20 wt. %, with respect to the weight of the hydraulic binder composition and the additive.

For example, SiC particles are chosen with a proportion of 10-22 wt. %, especially 15-20 wt. %, with respect to the weight of the hydraulic binder composition and the additive.

In another preferred embodiment, the silane-functional polymer is used in combination with fibers, in particular glass, carbon and/or plastic fibers. Glass fibers and/or plastic fibers are highly preferred. Highly preferred plastic fibers are polyalkylene fibers, e.g. polyethylene fibers. Fibers help to increase compression strength of the hydraulic binder compositions while keeping the flexibility.

A proportion of the fibers is preferably from 0.001-3 wt. %, in particular 0.01-2.0 wt. %, especially 0.1-1 wt. %, with respect to the weight of the hydraulic binder composition in dry state.

In general, a preferred length of the fibers is from 0.05-12 mm, especially 0.05-5 mm. A diameter of the fibers is for example 0.5-1′000 μm, especially 1-100 μm, in particular 5-40 μm.

A preferred additive for increasing the flexibility of a hydraulic binder composition comprises or consists of:
the silane-functional polymer as described above, especially with a proportion of 50-100 wt. %, in particular 65-95 wt. %, preferably 70-90 wt. %;
optionally, the catalyst for the hydrolysis and/or condensation of the silane-functional polymer, especially with a proportion of 0-10 wt. %, in particular 0.1-7 wt. %, preferably 1-5 wt. %;
optionally, the adhesion promoter, especially with a proportion of 0-40 wt. %, in particular 0.1-35 wt. %, preferably 1-10 wt. %, particularly 1-5 wt. %;
optionally, the surfactant, especially with a proportion of 0-40 wt. %, in particular 1-30 wt. %, preferably 5-20 wt. %, particularly 10-20 wt. %;
optionally, hard materials particles, especially with a proportion of 0.2-50 wt. %, in particular 2-40 wt. %, preferably 6-30 wt. %;
optionally, fibers, especially with a proportion of 0.002-6 wt. %, in particular 0.02-4 wt. %, especially 0.2-2 wt. %.
   whereby all of the proportions are with respect to the total weight of the additive as such.

The silane-functional polymer, the catalyst, the adhesion promoter, the surfactant, the hard materials particles, and the fibers are defined as described above.

Especially, the additive as such is essentially free of water. This means that an amount of water in the additive is below 1 wt. %, in particular below 0.5 wt. % or below 0.1 wt. % or 0 wt. %, with respect to the total weight of the additive as such.

A first highly preferred additive for increasing the flexibility of a hydraulic binder composition comprises or consists of:
the silane-functional polymer, especially silane-functional polyurethane polymer, in particular based on polyalkylene glycol polyols, with a proportion of 70-90 wt. %;
the surfactant, especially a homopolymer or a copolymer of alkylene oxides, optionally end capped with an alkyl group, with a proportion 10-20 wt. %;
optionally, the catalyst for the hydrolysis and/or condensation of the silane-functional polymer, especially a metal complex, with a proportion 1-5 wt. %;
optionally, the adhesion promoter, with a proportion 1-5 wt. %;
   whereby all of the proportions are with respect to the total weight of the additive as such.

The first highly preferred additive is in particular beneficial if used in rather high proportions, e.g. with a proportion of 15-50 wt. %, especially 25-40 wt. %, in particular 30-35 wt. %, with respect to the overall weight of the hydraulic binder composition and the additive. Especially, the first additive is used without water.

A second highly preferred additive for increasing the flexibility of a hydraulic binder composition comprises or consists of:
the silane-functional polymer, especially silane-functional polyurethane polymer, in particular based on polyalkylene glycol polyols with a proportion of >90-95 wt. %;
the adhesion promoter with a proportion 1-5 wt. %, especially an organosilane, in particular a silane having a primary amino group;
optionally, the catalyst for the hydrolysis and/or condensation of the silane-functional polymer, especially with a proportion 1-5 wt. %;
   whereby all of the proportions are with respect to the total weight of the additive as such.

The second highly preferred additive is in particular beneficial if used in rather low proportions, e.g. with a proportion of 0.01-<10 wt. %, especially 0.5-5 wt. %, with respect to the overall weight of the hydraulic binder composition and the additive. In this case, preferably, the additive is used in combination with water.

A third highly preferred additive for increasing the flexibility of a hydraulic binder composition comprises or consists of:
a silane-functional polyurethane polymer, in particular based on polyalkylene glycol polyols, with a proportion of 70-90 wt. %;
a homopolymer or a copolymer of alkylene oxides, optionally end capped with an alkyl group, as the surfactant with a proportion 10-20 wt. %;
a metal complex, especially a tin complex, as the catalyst for the hydrolysis and/or condensation of the silane-functional polymer, with a proportion 1-5 wt. %;
a silane having a primary amino group as the adhesion promoter with a proportion 1-5 wt. %;
   whereby all of the proportions are with respect to the total weight of the additive as such.

The third highly preferred additive is in particular beneficial if used in rather high proportions, e.g. with a proportion of 15-50 wt. %, especially 25-40 wt. %, in particular 30-35 wt. %, with respect to the overall weight of the hydraulic binder composition and the additive. Especially, the third additive is used without water.

According to a preferred embodiment, the additive is a one-component mixture. That means that all the individual materials and/or substances are intermixed. One-component compositions are in particular easy to handle and exclude the risk of a mix up or wrong dosing of individual components by users.

However, in another preferred embodiment, the additive is provided as a two-component additive composition, a three-component additive composition, a multi-component additive composition or as a kit-of-parts. A first component may e.g. be present in a first receptacle comprising the silane-functional polymer and optionally the adhesion promoter and the surfactant. A second component, present in a second receptacle, may comprise the catalyst. An optional third component, present in a third receptacle, may comprise hard materials particles and/or fibers. Other distributions are possible as well. Two-, three, or multi-component mortar compositions allow e.g. for flexibly adjusting the additive and the hydraulic binder composition with regard to specific applications.

According to a further preferred embodiment, the additive for increasing the flexibility of a hydraulic binder composition is used in combination with water.

However, in the present case, water is not considered as a component of the inventive additive. In particular, if water is used, it is provided separate from the silane-functional polymer or separate from the additive.

Preferably, water is used with a proportion of 0-30 wt. %, especially 1-20 wt. %, in particular 10-20 wt. %, particularly 12-17 wt. %, with respect to the weight of the hydraulic binder in the hydraulic binder composition. When using water, the compressive strength of the hydraulic binder composition can be increased.

However, according to a highly preferred embodiment, essentially no water is used. This means that the additive for increasing the flexibility of a hydraulic binder composition is used in combination with no water or with water in a proportion of 0-1 wt. %, especially 0-0.5 wt. %, in particular 0-0.1 wt. %, particularly 0 wt %, with respect to the hydraulic binder in the hydraulic binder composition.

As it turned out, maximum flexibility of the hydraulic binder composition can be achieved without water. In this case, however, it is beneficial to use the silane-functional polymer in combination with a surfactant, as described above.

According to another preferred embodiment, the inventive additive is used for increasing the flexibility of a hydraulic binder composition and at the same time for controlling, in particular increasing, the waterproofness of the hydraulic binder composition. As a measure for waterproofness, the liquid water permeability determined according to standard EN 1062-3:2008-04 is preferably taken.

Another aspect of the present invention is directed to a method for increasing, the flexibility of a hydraulic binder composition. The method comprises the steps of (i) providing an additive as described above and (ii) mixing the additive into a hydraulic binder composition.

In particular, step (i) can comprise mixing all of the components of a multi-component additive.

Especially, in step (ii), the additive is mixed into a dry hydraulic binder composition. In this case, preferably, no water is added to the hydraulic binder composition.

In another preferred method, in step (ii), the hydraulic binder composition is mixed with water before the additive is mixed in. Preferably, the additive is not mixed with water before adding it to the hydraulic binder composition.

In the method, the additive, the hydraulic binder composition as well as their proportions are the same as described above.

A further aspect of the present invention is a hydraulic binder composition, especially a grout composition, comprising an additive as described above. Thereby, the additive, the hydraulic binder composition as well as their proportions are the same as described above.

A further aspect of the present invention is a hydraulic binder composition obtainable by adding an additive an optionally water to a hydraulic binder composition as described above or obtainable by the method as described above. Preferably, the hydraulic binder composition is placed on a substrate, especially in a void. Also in this case, the additive, the hydraulic binder composition as well as their proportions are the same as described above.

Further advantageous configurations of the invention are evident from the exemplary embodiments.

### BRIEF DESCRIPTION OF THE DRAWINGS

The drawings used to explain the embodiments show:

FIG. 1 the strength versus elongation diagram of the three samples recorded in the bending flexibility tests;

FIG. 2 strength versus elongation diagram of the three samples recorded in the compression tests;

FIG. 3 a detailed view of the data recorded in the compressive tests.

### EXEMPLARY EMBODIMENTS

1. Additive Compositions

Table 1 shows three inventive additive compositions A1-A3. The additive compositions have been prepared by intermixing all of the components for 10 minutes under vacuum conditions in a glass bottle. Then the bottles were flushed with nitrogen and closed.

TABLE 1
Additive compositions

| Component | A1 | A2 | A3 |
|---|---|---|---|
| Silane-functional polymer¹⁾ [wt. %] | 79.6 | 81.7 | 93.8 |
| Adhesion promotor²⁾ [wt. %] | 2.6 | 2.7 | 3.1 |
| Catalyst³⁾ [wt. %] | 2.6 | 0 | 3.1 |
| Surfactant⁴⁾ [wt. %] | 15.2 | 15.6 | 0 |

¹⁾Geniosil STP-E15, polyether polyol endcapped with isocyanate-functional alkoxysilane, Wacker Chemie AG, Germany
²⁾Silquest A1110, primary amino silane, Momentive Performance Materials, USA
³⁾Tin catalyst comprising 10 wt.% dibutyltin dilaurate in diisodecyl phthalate
⁴⁾Dowfax DF-143, Polypropylene glycol monobutyl ether, Dow Chemical Company

The bottles with the additive compositions have been stored at 22° at 60% relative humidity for 6 months. At 0, 3 and 6 months, samples of the additive compositions have been taken in order to measure the evolution of the viscosities of the samples. Thereby, no significant changes in viscosities could be observed. Thus, all of the additive compositions A1-A3 turned out to be storage stable under the given conditions for at least 6 months.

2. Grout Compositions

Table 2 shows a grout composition HBC (=hydraulic binder composition) used in the working examples. The grout composition has been prepared by intermixing all of the components in dry state. Thus, the grout composition HBC is present in dry form.

TABLE 2
Grout compositions in dry state
(before adding additives and water)

| Component | HBC |
|---|---|
| Hydraulic binder [wt. %] | |
| Portland cement (CEM I, 52.5R) | 16.0 |
| Calcium sulfoaluminate cement¹⁾ | 19.6 |
| Calcium sulfate dihydrate | 0.6 |
| Aggregates [wt. %] | |
| Filler (calcium carbonate) | 4.5 |
| Sand (grain size 0.06-3.2 mm) | 42.2 |
| Calcium carbonate (0.7-1.2 mm) | 14.3 |
| Additives [wt. %] | |
| Plasticizer²⁾ | 0.4 |
| Processing additives³⁾ | 2.25 |

¹⁾AliCem, calcium sulfoaluminate cement, HeidelbergCement, Germany
²⁾Sika Viscocrete 425 P, polycarboxylate ether, Sika Germany GmbH, Germany
³⁾Defoamer, rheology modifiers, thixotropic agents, retarder, etc.

3. Use of the Additives in Grout Compositions

Additives A1-A3 have been used for controlling the flexibility of the grout composition HBC. Table 3 gives an overview of the proportions used.

TABLE 3
Processable grout compositions

| Component | P1 | P2 | P3 |
|---|---|---|---|
| Grout composition HBC [wt. %] | 66.7 | 67.5 | 97.2 |
| Additive A1 [wt. %] | 33.3 | — | — |
| Additive A2 [wt. %] | — | 32.5 | — |
| Additive A3 [wt. %] | — | — | 2.8 |
| Sum | 100.0 | 100.0 | 100.0 |
| Water [wt. % with respect to | — | 13 | 15 |
| hydraulic binder in grout | | | |
| composition HBC] | | | |

With processable grout compositions P2 and P3, in a first step the water has been mixed with the dry grout composition HBC for 3 minutes in order to obtain homogeneous mixtures. Then, in a second step, additive A2 or A3, respectively, were added and the so obtained mixtures have been mixed again for 5 minutes in order to obtain processable grout compositions.

For processable grout composition P1, additive A1 has been mixed directly with the dry grout composition HBC for 5 minutes in order to obtain a grout processable compositions.

4. Tests and Results

4.1 Workability

Flow table spread values were assessed according standard EN 12350-5:2009. 10 minutes after preparation, grout composition P3 showed a very good consistency and workability. Specifically, a flow table spread value of about 240 mm could be achieved.

The flow table spread values of grout compositions P1 and P2 were somewhat lower. Specifically, flow table spread values 10 minutes after preparation were about 160 mm for composition P2. Composition P1 featured a rather sticky consistence. Nevertheless, workability was still suitable for practical grouting applications.

4.2 Flexibility

For testing mechanical properties of the grout compositions P1-P3 after hardening, samples in the form of square prisms of the grout compositions with a size of 4 cm×4 cm×16 cm have been produced.

In order to check the bending flexibility, a bending moment was exerted on the prisms by load transmission through one upper and two lower rollers, similar to the procedure described in EN 12390-5 or ASTM C78 (simple beam with third-point loading). Thereby, a 1-point load application setup was used with the load transfer above through one roller in the center of the prisms and the lower rollers are at a distance of about 12 cm, i.e. about 3 times the height of the sample. Thereby, the load (or strength) acting through the load-transferring roller onto the sample was recorded as a function of the displacement or elongation, respectively, of the load transferring roller.

For checking the compressive flexibility, the prisms in upright position have been compressed along their longitudinal axes between two movable jaws. Thereby, the load (or strength) acting through the jaws onto the sample was recorded as a function of the displacement or elongation, respectively, of the jaws.

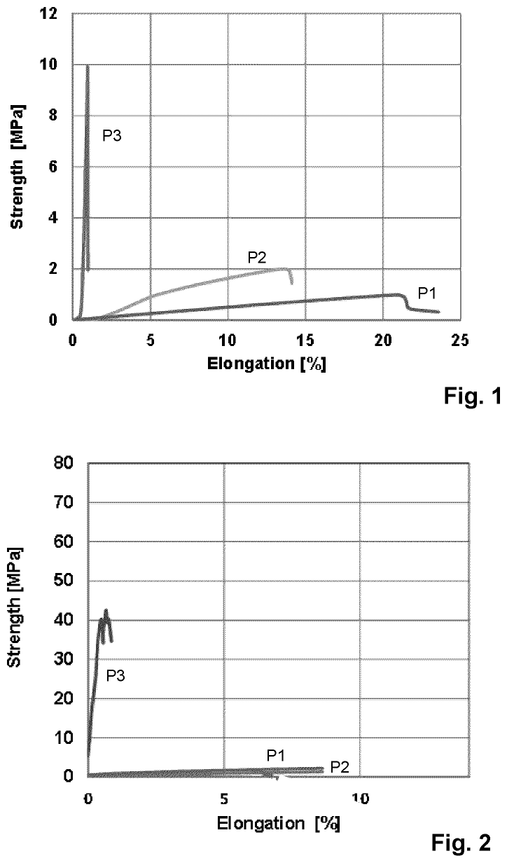

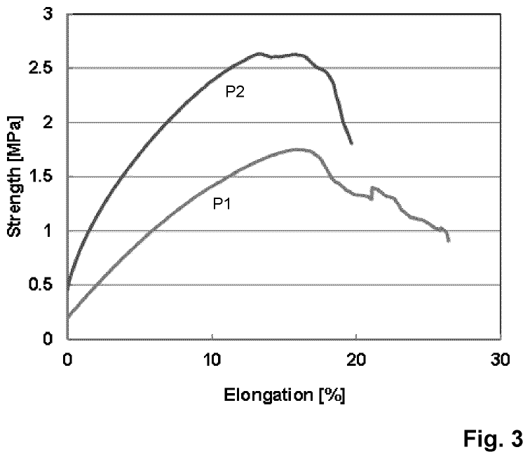

FIG. 1 shows a strength versus elongation diagram of the three samples P1-P3 recorded in the bending flexibility tests. FIG. 2 shows a strength versus elongation diagram of the three samples P1-P3 recorded in the compression tests. FIG. 3 is a detailed view of the data recorded in the compressive tests showing the differences between samples P2 and P3.

In general, the flatter the gradient of the function of strength versus elongation, the higher the flexibility of the sample.

As can be seen from the data shown in FIG. 1-3, sample P3 comprising additive A3 in rather low proportions is quite stiff or less flexible when compared to the other samples P1 and P2 comprising additives A1 or A2, respectively. When comparing samples P1 and P2, it turns out that sample P1 with additive A1 and without water is more flexible than sample P2 with additive P2 but with water.

4.3 Waterproofness

The liquid-water transmission rates (permeability) of the hardened samples have been tested according to EN 1062-3:2008-04. Thereby, the samples fulfilled the criteria to be classified as waterproof.

In summary, the use of the inventive additives allow for controlling and significantly increasing the flexibility of hydraulic binder compositions and at the same time achieving excellent waterproofness. Nevertheless, the grout compositions feature a practically suitable workability and mechanical properties.

It will be appreciated by those skilled in the art that the present invention can be embodied in other specific forms without departing from the spirit or essential characteristics thereof. The presently disclosed embodiments are therefore considered in all respects to be illustrative and not restricted.

1. A method comprising adding an additive to a hydraulic binder composition, the additive being added in an amount effective to increase the flexibility of the hydraulic binder composition, wherein the additive comprises a silane-functional polymer, and the silane-functional polymer is a silane-functional polyurethane polymer and/or a silane-functional polyether.

2. The method according to claim 1, wherein the hydraulic binder composition comprises an aluminate cement and/or a sulphoaluminate cement.

3. The method according to claim 1, wherein the hydraulic binder composition comprises aggregates selected from sand, quartz, calcium carbonate and/or gravel.

4. The method according to claim 1, wherein the silane-functional polymer has at least one functional group of the formula (I): 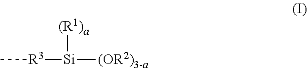
where
the radical R¹ is an alkyl group having 1 to 8 C atoms;
the radical R² is an acyl or alkyl group having 1 to 5 C atoms;
the radical R³ is a linear or branched, optionally cyclic, alkylene group having 1 to 12 C atoms, optionally with aromatic moieties, and optionally with 1 or more heteroatoms; and
the index a has a value of 0 or 1 or 2.

5. The method according to claim 1, wherein the silane-functional polymer has an average molecular weight Mn, determined by GPC against polystyrene standard, of between 4000 and 30 000 g/mol.

6. The method according to claim 1, wherein the silane-functional polymer is a polymer with a polypropylene glycol backbone or a polyethylene glycol and polypropylene glycol mixed backbone, optionally comprising urethane linkages.

7. The method according to claim 1, wherein the silane-functional polymer is a polymer with dialkoxy(alkyl)silylalkylcarbamate end groups and/or trialkoxysilylalkylcarbamate end groups.

8. The method according to claim 1, wherein the additive further comprises one or more of the following substances:
a catalyst for the hydrolysis and/or condensation of the silane-functional polymer;
an adhesion promoter;
a surfactant;
fibers; and/or
hard aggregates.

9. The method according to claim 1, wherein said additive comprises an adhesion promoter, said adhesion promoter being a silane having a primary amino group.

10. The method according to claim 1, wherein the additive comprises or consist of:
70-90 wt. % of the silane-functional polymer;
10-20 wt. % of the surfactant;
optionally, 1-5 wt. % of a catalyst for the hydrolysis and/or condensation of the silane-functional polymer;
optionally, 1-5 wt. % of an adhesion promoter;
the weight percentages being with respect to the total weight of the additive.

11. The method according to claim 1, wherein the additive is used in combination with no water.

12. An additive for increasing the flexibility of a hydraulic binder composition, the additive comprising:
70-90 wt. % of a silane-functional polymer, the silane-functional polymer being selected from silane-functional polyurethane polymers;
10-20 wt. % of a surfactant, the surfactant being selected from a homopolymer or a copolymer of alkylene oxides;
optionally, 1-5 wt. % of a catalyst for the hydrolysis and/or condensation of the silane-functional polymer; and
optionally, 1-5 wt. % of an adhesion promoter;
the weight percentages being with respect to the total weight of the additive.

13. The additive according to claim 12, wherein
1-5 wt. % of the catalyst is present in the additive, the catalyst being a metal complex; and
1-5 wt. % of the adhesion promoter is present in the additive, the adhesion promoter being a silane having a primary amino group;
the weight percentages being with respect to the total weight of the additive.

14. A method for increasing the flexibility of a hydraulic binder composition, the method comprising: (i) providing the additive of claim 12 and (ii) mixing the additive into a hydraulic binder composition.

15. A hydraulic binder composition comprising the additive of claim 12.

16. The method according to claim 2, wherein
the aluminate cement is comprised in the hydraulic binder composition, and
the aluminate cement is a calcium aluminate cement.

17. The method according to claim 2, wherein
the sulphoaluminate cement is comprised in the hydraulic binder composition, and
the sulphoaluminate cement is a calcium sulphoaluminate cement.
